(19) United States
(12) Patent Application Publication
(10) Pub. No.: US 2021/0276928 A1
(43) Pub. Date: Sep. 9, 2021

(54) FERTILIZER INCLUDING VERMICOMPOST AND METHOD OF MANUFACTURING A FERTILIZER INCLUDING VERMICOMPOST

(71) Applicant: Sartivite LLC, Williamsville, NY (US)

(72) Inventors: Brendan M. Cullinan, Clarence Center, NY (US); Denise H. Cullinan, Clarence Center, NY (US); Richard Andrew Bruno, II, Williamsville, NY (US)

(21) Appl. No.: 17/189,588

(22) Filed: Mar. 2, 2021

Related U.S. Application Data
(60) Provisional application No. 62/984,870, filed on Mar. 4, 2020.

(51) Int. Cl. C05F 17/05; C05F 17/10; C05G 5/23; C05G 3/50

(52) U.S. Cl. CPC C05F 17/05; C05G 3/50; C05G 5/23; C05F 17/10

(57) ABSTRACT

A method of manufacturing a fertilizer, including grinding solid vermicompost to create solid ground vermicompost powder, creating a liquid suspension agent, adding the solid ground vermicompost powder to the liquid suspension agent to create a liquified vermicompost solution, filtering the liquified vermicompost solution to create a concentrated liquified vermicompost mixture, and adding dispersant to the concentrated liquified vermicompost mixture.

### CROSS-REFERENCE TO RELATED APPLICATIONS

This application claims the benefit under 35 U.S.C. § 119(e) of U.S. Provisional Application No. 62/984,870, filed Mar. 4, 2020, which application is incorporated herein by reference in its entirety.

### FIELD

The present disclosure relates generally to fertilizers, and more particularly to a fertilizer using vermicompost, and even more particularly, to a fertilizer using a liquified vermicompost and a method of manufacturing the liquified vermicompost.

### BACKGROUND

Vermicompost (vermi-compost, vermiculture) is the product of the decomposition process using various species of worms, usually red wigglers, white worms, and other earthworms, to create a mixture of decomposing vegetable or food waste, bedding materials, and vermicast. Vermicast (also called worm castings, worm humus, worm manure, or worm feces) is the end-product of the breakdown of organic matter by earthworms. These castings have been shown to contain reduced levels of contaminants and a higher saturation of nutrients than the organic materials before vermicomposting. Vermicompost contains water-soluble nutrients and is an excellent, nutrient-rich organic fertilizer and soil conditioner. It is used in farming and small scale sustainable, organic farming.

Vermicomposting is an inexpensive method to enrich soils and reduce dependency on more expensive synthetic mineral fertilizers. Vermicomposting is also commonly referred to as worm composting, or vermiculture, all meaning the same. Vermicomposting involves the decomposition of typically carbohydrate-rich or other organic-rich waste constituents that are further consumed by specific worm species (e.g., red wigglers, earthworms, nightcrawlers, etc.). Via digestion, the byproduct streams of these ‘worm castings’ typically undergo a beneficial change to a nutrient-rich composition of organic acids, amino acids, and other trace minerals and biologicals, all highly beneficial to plant growth through nutrient exchange and respiration.

Vermicomposting research has shown significant reduction in CO2, methane and nitrous oxide emissions of waste streams consumed via digestion, in particular vermicompost derived from cow manure. The conversion to labile biological and chemical compositions highly beneficial to plant growth are essential to the future development of plant fertilizers. In the face of a population expansion and potential changing global climate, the unavoidable requirement will necessarily require more efficiently grown food and feed in suboptimal soils.

Vermicompost contains a variety of water-soluble and water insoluble nutrient-rich organics, fertilizers, and soil conditioners, that are easily absorbed by the plant environment. During digestion, earthworms uniformly mince minerals and organic waste into simple, more labile forms. This distinct process enables plants to access and utilize nutrients and minerals in more basic forms, with plants needing only nominal energy to acquire these labile nutrients. The worms' digestive systems create these living soil environments, environments that allow certain distinct species of microbes that protect the plant from pathogens and enable the plant to thrive without the employment of synthetic nutrients.

Vermicompost has multiple benefits. Vermicompost enhances germination, plant growth, and crop yield, improves root growth and structure, and enriches soil with micro-organisms. With respect to the environment, the use of vermicompost helps greenhouse gas emissions such as methane and nitrous oxide.

However, known vermicompost is solid (i.e., a solid agglomerate) and can be difficult to spread when used in large scale or commercial settings. Known vermicompost does not inhibit a concentration that creates the highest possible fertilizing effect on plants. Furthermore, current vermicompost aqueous extracts (or teas) only utilize less than 1% of the total weight of vermicompost solid.

Thus, there is a long felt need for a fertilizer and a method of manufacturing a fertilizer that optimizes the use of vermicompost such that the fertilizer can be spreadable through an existing irrigation system and produces the best fertilizing effect on the plants it is applied to.

### SUMMARY

According to aspects illustrated herein, there is provided a method of manufacturing a fertilizer, comprising grinding solid vermicompost to create solid ground vermicompost powder, creating a liquid suspension agent, adding the solid ground vermicompost powder to the liquid suspension agent to create a liquified vermicompost solution, filtering the liquified vermicompost solution to create a concentrated liquified vermicompost mixture, and adding dispersant to the concentrated liquified vermicompost mixture.

In some embodiments, the step of creating a liquid suspension agent comprises mixing a thickening agent with water. In some embodiments, the thickening agent is selected from the group consisting of cellulosic thickener, cellulose gum, cellulose ethers, and xanthan gum. In some embodiments, the thickening agent is xanthan gum. In some embodiments, the step of adding the solid vermicompost powder to the liquid suspension agent to create a liquified vermicompost solution comprises adding the solid vermicompost powder to the liquified vermicompost solution under high speed mixing. In some embodiments, the method further comprises adding a surfactant to the liquified vermicompost solution. In some embodiments, the step of filtering the liquified vermicompost solution to create a concentrated liquified vermicompost mixture comprises separating purified vermicompost of the liquid vermicompost solution from waste vermicompost of the liquid vermicompost solution via gravity, and separating the purified vermicompost from the waste vermicompost via decanting. In some embodiments, the method further comprises collecting and cleaning the waste vermicompost to be further processed for additional vermicompost. In some embodiments, the dispersant comprises one or more surfactants.

According to aspects illustrated herein, there is provided a method of manufacturing a fertilizer, comprising creating a liquid suspension agent, creating a dispersing agent solution, mixing the liquid suspension agent and the dispersing agent solution to create a premix solution, and adding solid vermicompost to the premix solution while grinding to create a liquified vermicompost mixture.

In some embodiments, the step of mixing the liquid suspension agent and the dispersing agent solution to create a premix solution comprises mixing the liquid suspension agent and the dispersing agent solution while grinding to create the premix solution. In some embodiments, the step of creating a liquid suspension agent comprises mixing a thickening agent with water. In some embodiments, the thickening agent is xanthan gum. In some embodiments, the step of creating a dispersing agent solution comprises mixing a dispersing agent with water. In some embodiments, the dispersing agent comprises one or more surfactants. In some embodiments, the step of adding solid vermicompost to the premix solution while grinding to create a concentrated liquified vermicompost mixture comprises grinding the solid vermicompost to create ground solid vermicompost, and adding the ground solid vermicompost to the premix solution while grinding to create the concentrated liquified vermicompost mixture. In some embodiments, the method further comprises the step of grinding the liquified vermicompost mixture. In some embodiments, the method further comprises the step of adding water to the liquified vermicompost mixture. In some embodiments, the method further comprises the step of filtering and/or decanting the vermicompost mixture to create a concentrated liquified vermicompost mixture.

According to aspects illustrated herein, there is provided a method of manufacturing a fertilizer, comprising creating a dispersing agent solution, adding solid vermicompost to the dispersing agent solution while grinding to create a liquified vermicompost solution, creating a liquid suspension agent, and adding the liquid suspension agent to the liquified vermicompost solution while grinding to create a liquified vermicompost mixture.

In some embodiments, the step of creating a liquid suspension agent comprises mixing a thickening agent with water. In some embodiments, the thickening agent is xanthan gum. In some embodiments, the step of creating a dispersing agent solution comprises mixing a dispersing agent with water. In some embodiments, the method further comprises the step of grinding the liquified vermicompost mixture. In some embodiments, the method further comprises the step of adding water to the liquified vermicompost mixture.

According to aspects illustrated herein, there is provided a liquified vermicompost mixture to be used as a fertilizer, comprising a thickening agent, a dispersing agent, vermicompost, and water.

In some embodiments, the vermicompost comprises ground worm castings. In some embodiments, the thickening agent comprises xanthan gum. In some embodiments, the dispersing agent comprises one or more surfactants.

A method of manufacturing a fertilizer, comprising creating a dispersing agent solution, adding solid vermicompost to the dispersing agent solution while grinding to create a liquified vermicompost solution, creating a liquid suspension agent, and adding the liquid suspension agent to the liquified vermicompost solution while grinding to create a concentrated liquified vermicompost mixture.

A liquified vermicompost mixture to be used as a fertilizer, comprising a thickening agent, a dispersing agent, vermicompost, and water.

The present disclosure includes a fertilizer comprising a dispersion of vermicompost developed to improve plant fertilizer efficacy. While solid vermicompost is a proven fertilizer in leafy plants and fruits, but its delivery system is sluggish (since vermicompost is a solid agglomerate). The fertilizer of the present disclosure converts solid vermicompost to a dispersible mixture at a high concentration that increases the surface area of the solid vermicompost by approximately 1,000 times. The present disclosure includes a method that micronizes and encapsulates the vermicompost to enable uniform distribution of ultrafine vermicompost particles throughout a solution, while also preventing the encapsulated vermicompost from settling to the bottom of the mixture (i.e., the ultrafine vermicompost particles maintain its disbursement throughout the mixture due to the mixture's unique viscosity).

The fertilizer of the present disclosure is rich in phenolic and polyphenolic metabolites. As we are aware, the multifunctionality present on the phenolic metabolites in the fertilizer bond extremely well, and are particularly efficient in providing plant nutrition, and active transport of desirable ions in the soil (and from air) without addition of Nitrogen, Phosphorus, or Potassium. The microfine encapsulation of the fertilizer enables the efficient uptake of water through the plant membrane via osmotic pressure. Plants treated with the fertilizer of the present disclosure exhibit instant erectness (i.e., plants stand erect minutes after treatment), which is evidence of diffusion through the cell.

The fertilizer of the present disclosure yields a nearly 50% increase in plant terpenes, especially the most valued terpenes (terpinolene, alpha/beta-pinene, terpineol, etc.) that were scarce under standard fertilization, but manifest in plants treated with the present disclosure fertilizer. Terpinolene plays a key role in defining the taste and smell of many cannabis strains, including the immensely popular, terpinolene-dominant strains. Terpinolene may also affect a strain's therapeutic and experiential qualities. Terpinolene is a combination of terpenes—part pinene, part d-Limonene, part floral—bringing with it a variety of benefits including intense aroma increase as well as antioxidant, medicinal, and plant protection (antibacterial properties, hence terpinolene's widespread use in cleaning products. Terpinolene also has a secondary effect as a pest repellent. The terpinolene content in most plants is near zero, while the plants treated with the present disclosure fertilizer shows a terpinolene increase of almost 50%. Additionally, plants treated with the present disclosure fertilizer exhibit lower plant waste than those treated with standard fertilizer.

The present disclosure fertilizer generally comprises a water dispersible concentrate of vermicompost (i.e., liquified vermicompost). The present disclosure fertilizer increases the ease of handling, dilution, and application, can vary in concentration depending on user needs/demands, is inexpensive to manufacture, comprises ultra-fine vermicompost particle size that better penetrates and disperses in soils and emancipates biological community while maintaining the beneficial, non-water soluble components of solid vermicompost, and can be converted back to free-flowing powder from concentrate via a method without heat drying.

The present disclosure fertilizer generally comprises a water dispersible concentrate that exhibits 100% yield, largescale production in a short amount of time, an increased solid vermicompost surface area of 1,000 times, a high output microbial community, a sprayable viscosity (i.e., liquid delivery system) at standard user concentrates, for example, 1-5%, and that can be easily adapted to multiple application requirements (i.e., soil or hydroponics).

The present disclosure fertilizer utilizes 95%-100% of all vermicompost solid for conversion to ultra-micronized liquefied vermicompost.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a flow chart depicting operational steps for manufacturing a fertilizer, according to an embodiment of the present disclosure;

FIG. 2 is a flow chart depicting operational steps for manufacturing a fertilizer, according to an embodiment of the present disclosure; and,

FIG. 3 is a flow chart depicting operational steps for manufacturing a fertilizer, according to an embodiment of the present disclosure.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. The assembly of the present disclosure could be driven by hydraulics, electronics, pneumatics, and/or springs.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

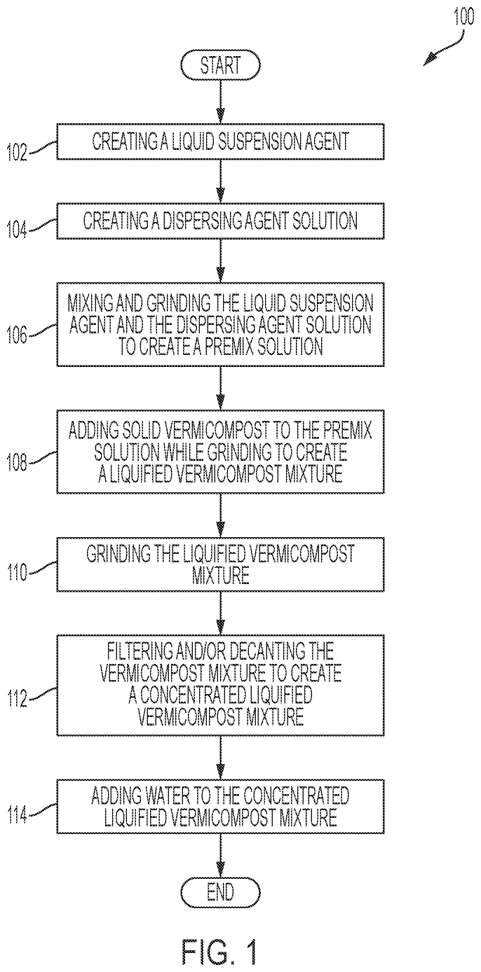

Referring now to the figures, FIG. 1 is a flow chart 100 depicting operational steps for manufacturing a fertilizer, according to an embodiment of the present disclosure.

In step 102, a liquid suspension agent is created. The liquid suspension agent is created by mixing a thickening agent with water. In some embodiments, the thickening agent is added to water to create the liquid suspension agent. The thickening agent may be, for example, a cellulosic material (i.e., cellulosic thickener, cellulose gum, etc.), a polysaccharide (e.g., xanthan gum), or any other suitable effective thickening agent or organic or synthetic thickeners.

In step 104, a dispersing agent solution is created. The dispersing agent solution is created by mixing a dispersing agent (i.e., a dispersant, plasticizer, or superplasticizer) with water. The dispersing agent is used to improve the separation of particles and to prevent settling or clumping (i.e., of the vermicompost). The dispersant may comprise one or more surfactants. In some embodiments, the dispersing agent is added to the water. In some embodiments, the dispersant is ammonia, pyrrolidone, or other mixtures of non-ionic surfactants and dispersants.

In step 106, a premix solution is created. The premix solution is created by mixing the liquid suspension agent, created in step 102, and the dispersing agent solution, created in step 104, together. In some embodiments, the premix solution is created by mixing and grinding the liquid suspension agent, created in step 102, and the dispersing agent solution, created in step 104, together. Grinding, in step 106, or any other step, may occur at 100-55,000 rpm.

In some embodiments, prior to step 108, a further step of grinding the solid vermicompost is included to create a ground solid vermicompost. Then, in step 108, the ground solid vermicompost is added to the premix solution accordingly to the description with respect to step 108 below.

In step 108, a liquified vermicompost mixture is created. The liquified vermicompost mixture is created by adding solid vermicompost to the premix solution, created in step 106. In some embodiments, the liquified vermicompost mixture is created by adding solid vermicompost to the premix solution, created in step 106, while also grinding. The vermicompost or worm castings are slowly added to the premix solution while grinding at room temperature. By adding the vermicompost to the premix solution while grinding, the surface area of the worm castings is increased (e.g., by 1,000 times) while maintaining an even distribution of the ground worm castings within the premix solution (i.e., the liquified vermicompost mixture includes an even consistency of ground worm castings and premix solution). In some embodiments, the particle size of the vermicompost is increased in the range of 10-10,000 times. In some embodiments, the mixing and/or grinding in step 108 occurs for 30 seconds to fifteen minutes. However, it should be appreciated that the mixing and/or grinding in step 108 may be adjusted based on the volume of the solution to be mixed. At this point, the liquified vermicompost mixture can be distributed via an irrigation system.

The following steps, namely, steps 110, 112, and 114, are included to adjust the concentration of the liquified vermicompost mixture, and are thus optional.

In step 110, the liquified vermicompost mixture is further grinded. Additional grinding may increase the surface area of the vermicompost thereby increasing the concentration of vermicompost within the premix solution. In some embodiments, the liquified vermicompost mixture is grinded via a three roll mill. In some embodiments, the liquified vermicompost mixture is further grinded while maintaining the same homogenous mixture. In some embodiments, the liquified vermicompost mixture is further grinded between one minute to twenty four hours.

In step 112, the liquified vermicompost mixture is filtered and/or decanted to create a concentrated liquified vermicompost mixture. In some embodiments, the liquified vermicompost mixture is filtered using a filtration cloth.

In step 114, water is added to the concentrated liquified vermicompost mixture.

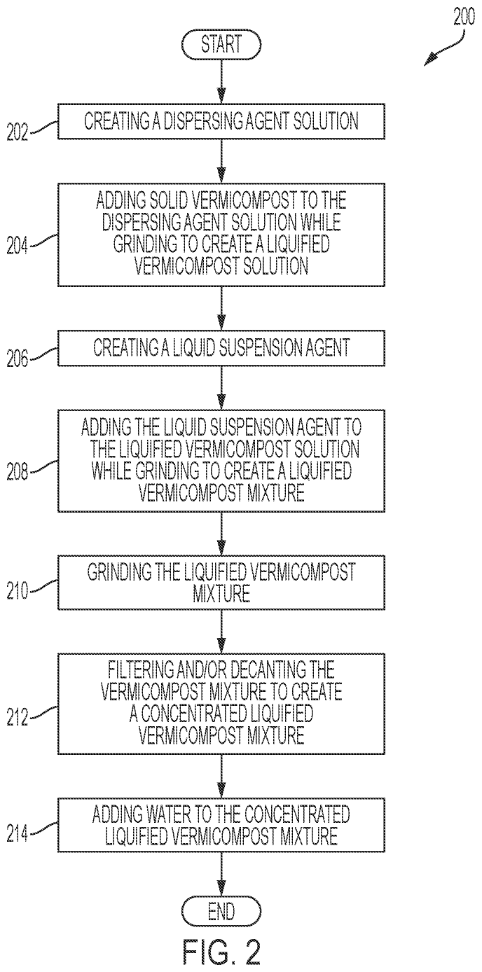

FIG. 2 is a flow chart 200 depicting operational steps for manufacturing a fertilizer, according to an embodiment of the present disclosure.

In step 202, a dispersing agent solution is created. The dispersing agent solution is created by mixing a dispersing agent (i.e., a dispersant, plasticizer, or superplasticizer) with water. The dispersing agent is used to improve the separation of particles and to prevent settling or clumping (i.e., of the vermicompost). The dispersant may comprise one or more surfactants. In some embodiments, the dispersing agent is added to the water. In some embodiments, the dispersant is ammonia, pyrrolidone, or other mixtures of nonionic and anionic surfactants and dispersants.

In some embodiments, prior to step 204, a further step of grinding the solid vermicompost is included to create a ground solid vermicompost. Then, in step 204, the ground solid vermicompost is added to the dispersing agent solution accordingly to the description with respect to step 204 below.

In step 204, a liquified vermicompost solution is created. The liquified vermicompost solution is created by adding solid vermicompost to the dispersing agent solution, created in step 202. In some embodiments, the liquified vermicompost solution is created by adding solid vermicompost to the dispersing agent solution, created in step 202, while also grinding. The vermicompost or worm castings are slowly added to the dispersing agent solution while grinding at room temperature. By adding the vermicompost to the dispersing agent solution while grinding, the surface area of the worm castings is increased (e.g., by 1,000 times) while maintaining an even distribution of the ground worm castings within the dispersing agent solution (i.e., the liquified vermicompost solution includes an even consistency of ground worm castings and dispersing agent solution). In some embodiments, the particle size of the vermicompost is increased in the range of 10-10,000 times. In some embodiments, the mixing and/or grinding in step 204 occurs for 30 seconds to fifteen minutes. However, it should be appreciated that the mixing and/or grinding in step 204 may be adjusted based on the volume of the solution to be mixed. Grinding, in step 204, or any other step, may occur at 100-55,000 rpm.

In step 206, a liquid suspension agent is created. The liquid suspension agent is created by mixing a thickening agent with water. In some embodiments, the thickening agent is added to water to create the liquid suspension agent. The thickening agent may be, for example, a cellulosic material (i.e., cellulosic thickener, cellulose gum, etc.), a polysaccharide (e.g., xanthan gum), or any other suitable effective thickening agent or organic or synthetic thickeners. Grinding, in step 206, or any other step, may occur at 100-55,000 rpm.

In step 208, a liquified vermicompost mixture is created. The liquified vermicompost mixture is created by adding the liquid suspension agent, created in step 206, to the liquified vermicompost solution, created in step 204. In some embodiments, the liquified vermicompost mixture is created by adding the liquid suspension agent, created in step 206, to the liquified vermicompost solution, created in step 204, while also grinding. At this point, the liquified vermicompost mixture can be distributed via an irrigation system.

The following steps, namely, steps 210, 212, and 214, are included to adjust the concentration of the liquified vermicompost mixture, and are thus optional.

In step 210, the liquified vermicompost mixture is further grinded. Additional grinding may increase the surface area of the vermicompost thereby increasing the concentration of vermicompost within the premix solution.

In step 212, the liquified vermicompost mixture is filtered and/or decanted to create a concentrated liquified vermicompost mixture.

In step 214, water is added to the concentrated liquified vermicompost mixture.

The resulting fertilizer of any of the methods of manufacture may include a liquefied vermicompost mixture, comprising a thickening agent, a dispersing agent, vermicompost, and water. In some embodiments, the thickening agent comprises a cellulosic material such as, for example, xanthan gum. In some embodiments, the dispersing agent comprises one or more surfactants. In some embodiments, the dispersing agent is in the range of 0.01% to 10% by weight of the liquified vermicompost mixture fertilizer. In some embodiments, the vermicompost comprises ground worm castings.

Testing of the present disclosure liquified vermicompost mixture fertilizer has shown substantial improvements over plants untreated with any fertilizer as well as over plants treated with other fertilizers. For example, the present disclosure liquified vermicompost mixture fertilizer greatly increases root mass versus competitive fertilizers. In one study, a test was performed on snapdragons. Snapdragons are the most or one of the most disease-prone commonly grown flowers. Snapdragons are prone to insect infestation. Tests were performed on 200 snapdragons, with 100 snapdragons being treated with the competitive synthetic fertilizer and 100 snapdragons being treated with the liquid vermicompost mixture fertilizer of the present disclosure, with all other soil preparation maintained throughout all 200 snapdragons. The results are shown in the chart below:

| | Liquid | |
|---|---|---|
| | Competitive | Vermicompost |
| | Fertilizer | Mixture |
| | Treated | Treated |
| Testing | Snapdragons | Snapdragons |
| Property | (100 Plants) | (100 Plants) |
| Number | 70 | 99 |
| of Plants | | |
| Reaching | | |
| Germination | | |
| Plant | Slow | Rapid |
| Response | germination | germination |
| Plant | Average | Robust |
| Growth | plant | plant |
| | growth | growth, |
| | | no droop |
| Plant | Bright | Extremely |
| Colors | | bright, |
| | | diverse |
| Aroma | Slight | Fragrant |

Thus, synthetic competitive fertilizer treated snapdragons only yielded 70%, with 30% attrition. Whereas the snapdragons treated with the liquid vermicompost mixture yielded 99%, grew far faster and with greater color diversity. The snapdragons treated with liquid vermicompost mixture fertilizer also regrew three times in one season and reseeded themselves into approximately 1,000 snapdragons.

The liquid vermicompost mixture fertilizer of the present disclosure is a hyper-catalysis which exhibits dramatic catalytic effects of the encapsulated fine particle size dispersion (i.e., the ground vermicompost in the dispersing agent and/or liquid suspension agent), and the resultant surface area increase. It has been shown that a 2% concentrate liquid vermicompost solution diluted 10 times with water is more effective than solid vermicompost, with faster results, richer plant maturity, and better root growth.

Testing has also indicated excellent plant growth in substandard soils with the use of the liquid vermicompost mixture fertilizer. Topsoil depleted seed planting exhibited strong plant growth when treated with the liquid vermicompost mixture. The liquid vermicompost mixture is rich in amino acids and other organic acids and sugars (formed from the worm breakdown of the carbohydrate rich compost).

In another test, terpene was measured in plants, with some plants used as a control and other plants treated with liquid vermicompost mixture fertilizer. The results are shown in the chart below:

| | Control | Test |
|---|---|---|
| Terpene | (mg/g) | (mg/g) |
| Terpinolene | 0.00 | 2.17 |
| α-Pinene | 1.10 | 1.92 |
| β-Caryophyllene | 1.93 | 1.63 |
| β-Pinene | 0.71 | 1.33 |
| (−)-α-Bisabolol | 0.69 | 0.88 |
| α-Humulene | 0.76 | 0.62 |
| δ-Limonene | 0.46 | 0.50 |
| Linalool | 0.30 | 0.44 |
| δ-3-Carene | 0.00 | 0.44 |
| ρ-Cymene | 0.00 | 0.38 |
| Camphene | 0.32 | 0.35 |
| (−)-Guaiol | 0.41 | 0.35 |
| Eucalyptol | 0.00 | 0.35 |
| γ-Terpinene | 0.00 | 0.31 |
| α-Terpinene | 0.00 | 0.30 |
| Oxide trans-Nerolidol | 0.14 | 0.00 |
| Total | 9.09 | 13.59 |

As such, the use of liquid vermicompost mixture fertilizer demonstrated a 49.5% increase in terpenes.

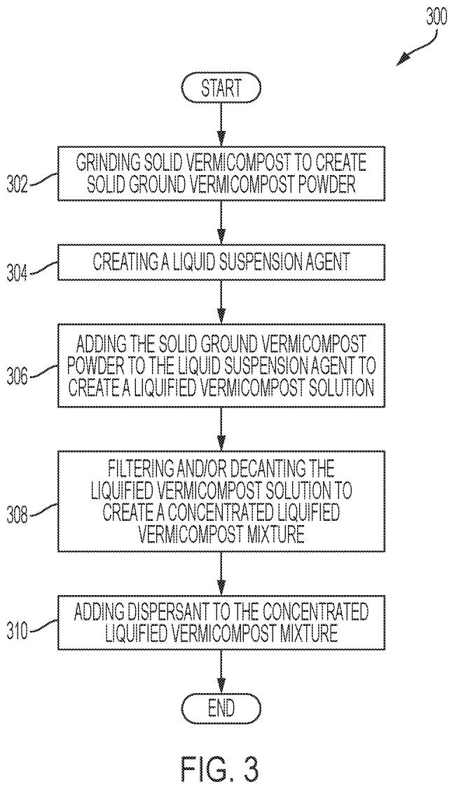

FIG. 3 is a flow chart 300 depicting operational steps for manufacturing a fertilizer, according to an embodiment of the present disclosure.

In step 302, solid ground vermicompost powder is created. Specifically, solid vermicompost is ground into a fine powder. This can be achieved quickly and efficiently in high-speed grinding equipment. It should be appreciated that the grinding equipment must not generate excess levels of heat that may be detrimental to the natural composition of the vermicompost nutrients. As such, in some embodiments, in an additional step, during grinding, the temperature of the vermicompost is regulated such that it does not exceed a predetermined temperature. Furthermore, grinding of the vermicompost may create dust and proper care should be taken to prevent generation excess nuisance dust. In some embodiments, once the solid ground vermicompost powder is created, it is set aside.

In step 304, a liquid suspension agent is created. The liquid suspension agent is created by mixing a thickening agent with water. In some embodiments, the thickening agent is added to water to create the liquid suspension agent. The thickening agent may be, for example, a cellulosic material (i.e., cellulosic thickener, cellulose gum, cellulose ethers, etc.), a polysaccharide (e.g., xanthan gum), or any other suitable effective thickening agent or organic or synthetic thickeners. In some embodiments, the thickening agent comprises one or more thixotropic agents or thixotropes effective in suspending solid materials in a water solution. In some embodiments, the solution of liquid suspension agent consists of 1% to 20% of thickener.

In step 306, a liquified vermicompost solution is created. The liquified vermicompost solution is created by adding the solid ground vermicompost powder to the liquid suspension agent. The solid ground vermicompost powder is added slowly under high speed mixing to the liquid suspension agent, and mixed for 1 minute to 30 minutes. This step further breaks down the particle size of the vermicompost. In some embodiments, a wetting agent or surfactant is added to the liquified vermicompost solution before, during, and/or after adding the solid ground vermicompost powder to the liquid suspension agent.

In step 308, the liquified vermicompost solution is filtered and/or decanted to create a concentrated liquified vermicompost mixture. The liquified vermicompost solution is let to sit to enable the natural separation (through gravity) of the lighter weight vermicompost solution, or the purified vermicompost, from the denser inert “dirt” insoluble (i.e., sedimentation), or waste vermicompost, consumed by the worms during the solid vermicompost process. The purified vermicompost is further filtered and separated via decanting. The waste inert sediment, typically ranging from 4% to 13% by weight, and due to density difference, approximately 2% to 7% by volume, may have sufficient reclaimable vermicompost that can be cleaned to extract more solution vermicompost, a further step to separate refined vermicompost from sedimentation.

In step 310, a dispersant or dispersing agent is added to the concentrated liquified vermicompost mixture. The concentrated liquified vermicompost mixture is mixed under mild to heavy agitation while adding dispersant for uniform distribution of vermicompost solution in a pre-thickened water solution. This process will again break down particle size further, and create a uniform solid brown solution.

Depending on the solids vermicompost source, in some embodiments, in an additional step, a letdown phase may be optimal and can be achieved by adding back additional liquid suspension agent (i.e., xanthan gum/cellulose ether/thixotrope solution) to desired viscosity and suspension properties for optimized fine particle size vermicompost. In some embodiments, additional dispersant may also be added to maximize wetting and dispersing of refined vermicompost solution.

It should be appreciated that in some embodiments, the processes and steps of flow charts 100, 200, and 300 can be employed interchangeably. It should also be appreciated that in some embodiments, with the proper grinding and dispersing equipment, the initial grinding step may be eliminated. In some embodiments, the net level of thixotrope/suspending agents and dispersing and wetting agents will remain roughly the same in the processes of flow charts 100, 200, and 300.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

100 Flow chart
102 Step
104 Step
106 Step
108 Step
110 Step
112 Step
114 Step
200 Flow chart
202 Step
204 Step
206 Step
208 Step
210 Step
212 Step
214 Step
300 Flow chart
302 Step
304 Step
306 Step
308 Step
310 Step

What is claimed is:

1. A method of manufacturing a fertilizer, comprising:
grinding solid vermicompost to create solid ground vermicompost powder;
creating a liquid suspension agent;
adding the solid ground vermicompost powder to the liquid suspension agent to create a liquified vermicompost solution;
filtering the liquified vermicompost solution to create a concentrated liquified vermicompost mixture; and,
adding dispersant to the concentrated liquified vermicompost mixture.

2. The method as recited in claim 1, wherein the step of creating a liquid suspension agent comprises:
mixing a thickening agent with water.

3. The method as recited in claim 2, wherein the thickening agent is selected from the group consisting of cellulosic thickener, cellulose gum, cellulose ethers, and xanthan gum.

4. The method as recited in claim 2, wherein the thickening agent is xanthan gum.

5. The method as recited in claim 1, wherein the step of adding the solid vermicompost powder to the liquid suspension agent to create a liquified vermicompost solution comprises:
adding the solid vermicompost powder to the liquified vermicompost solution under high speed mixing.

6. The method as recited in claim 1, further comprising:
adding a surfactant to the liquified vermicompost solution.

7. The method as recited in claim 1, wherein the step of filtering the liquified vermicompost solution to create a concentrated liquified vermicompost mixture comprises:
separating purified vermicompost of the liquid vermicompost solution from waste vermicompost of the liquid vermicompost solution via gravity; and,
separating the purified vermicompost from the waste vermicompost via decanting.

8. The method as recited in claim 7, further comprising:
collecting and cleaning the waste vermicompost to be further processed for additional vermicompost.

9. The method as recited in claim 1, wherein the dispersant comprises one or more surfactants.

10. A method of manufacturing a fertilizer, comprising:
creating a liquid suspension agent;
creating a dispersing agent solution;
mixing the liquid suspension agent and the dispersing agent solution to create a premix solution; and,
adding solid vermicompost to the premix solution while grinding to create a liquified vermicompost mixture.

11. The method as recited in claim 1, wherein the step of mixing the liquid suspension agent and the dispersing agent solution to create a premix solution comprises:
mixing the liquid suspension agent and the dispersing agent solution while grinding to create the premix solution.

12. The method as recited in claim 1, wherein the step of creating a liquid suspension agent comprises:
mixing a thickening agent with water.

13. The method as recited in claim 10, wherein the step of creating a dispersing agent solution comprises:
mixing a dispersing agent with water.

14. The method as recited in claim 10, wherein the step of adding solid vermicompost to the premix solution while grinding to create a concentrated liquified vermicompost mixture comprises:
grinding the solid vermicompost to create ground solid vermicompost; and,
adding the ground solid vermicompost to the premix solution while grinding to create the concentrated liquified vermicompost mixture.

15. The method as recited in claim 10, further comprising the step of:
grinding the liquified vermicompost mixture.

16. The method as recited in claim 10, further comprising the step of:
adding water to the liquified vermicompost mixture.

17. The method as recited in claim 10, further comprising the step of:
filtering and/or decanting the vermicompost mixture to create a concentrated liquified vermicompost mixture.

18. A liquified vermicompost mixture to be used as a fertilizer, comprising:
a thickening agent;
a dispersing agent;
vermicompost; and,
water.

19. The liquified vermicompost mixture as recited in claim 18, wherein the vermicompost comprises ground worm castings.

20. The liquified vermicompost mixture as recited in claim 17, wherein the dispersing agent comprises one or more surfactants.
